(19) United States
(12) Patent Application Publication
(10) Pub. No.: US 2001/0013052 A1
(43) Pub. Date: Aug. 9, 2001

(54) Universal method and apparatus for disparate systems to communicate

(76) Inventors: Yobie Benjamin, Fremont, CA (US); Greg Hoglund, Clarkston, WA (US); Abhideep Singh, San Francisco, CA (US); Jonathan Gary, Portland, OR (US)

Correspondence Address: ARLEN L. OLSEN, SCHMEISER, OLSEN & WATTS, 3 LEAR JET LANE, SUITE 201, LATHAM, NY, 12110, US

(21) Appl. No.: 09/681,401

(22) Filed: Mar. 29, 2001

Related U.S. Application Data
(60) Provisional application No. 60/243,218, filed on Oct. 25, 2000.

(51) Int. Cl. G06F 15/16

(52) U.S. Cl. 709/203; 709/245

(57) ABSTRACT

A system and method for disparate systems to communicate with each other, including a nodal network for distributed processing and caching. The nodal network includes at least one node. The at least one node is coupleable to an Internet. A main server is coupled to the Internet. An application and a database each coupled to the main server. Each node comprises a network server, a Distributed Working Environment for Application Processing (DWEAP) for execution of a runnable module (RUM) of the application, an application module cache for caching the RUM, and a synchronized database cache for caching a portion of the database. The portion of database is required for execution of the application.

### BACKGROUND OF INVENTION

1. Technical Field

The present invention relates generally to a system and method for disparate systems to communicate with each other, and more particularly to a nodal network for distributed processing and caching.

2. Related Art

FIG. 1 depicts a distributed network 10 of computers on an Internet 12 based a client-server model, in accordance with the related art. A client 14 is a machine (e.g., a personal computer or computer terminal) located in front of a user. The client 14 has a web browser and the client 14 uses the web browser to make a request, such as a request for a web page, from a server 16. The server 16 a computer which responds to such requests from the client 14 such as by sending the requested web page to the client 14 said sent web page may be displayed by web browser. The server 16 is able to respond to such requests from the client 14 by running one or more application modules 18. The client 14 does not send a request directly to the server 16, but rather sends the request to an ISP (i.e., Internet Service Provider) 19, and the ISP 19 sends the request across the Internet 12 to the server 16.

The Internet 12 serves as a communication interface between the client 14 and the server 16, or between the ISP 19 and the server 16. Unfortunately, the 12 may significantly reduce the speed of information transfer between the client 14 and the server 16, or between the ISP 19 and the server 16. Thus, the Internet introduces a high latency into the rate of said information transfer which delays the information transfer. Additionally, the server 16 may be subject to high demand from multiple clients and may reach a physical limiting point at which server 16 is no longer able to serve the ever expanding numbers of clients and associated users.

There is a need for increasing the rate information transfer in response to a client request. There is also a need for a server to be able to serve the ever expanding numbers of clients and associated users.

### SUMMARY OF INVENTION

The present invention provides a system for distributed processing, comprising at least one Distributed Working Environment for Application Processing (DWEAP), wherein the at least one DWEAP is coupleable to an Internet Service Provider (ISP), wherein the ISP is coupled to an Internet, wherein a main server is coupled to the Internet, wherein an application is coupled to the main server, and wherein each DWEAP has an application cache for caching a runnable module (RUM) of the application.

The present invention provides a system for distributed processing, comprising at least one node, wherein the at least one node is coupleable to an Internet, wherein a main server is coupled to the Internet, wherein an application is coupled to the main server, wherein each said node comprises a network server, a Distributed Working Environment for Application Processing (DWEAP) for execution of a runnable module (RUM) of the application, and an application module cache caching the RUM.

The present invention provides an application comprising a plurality of modules (RUMs), wherein the application is coupled to a main server, wherein the main server is coupled to an Internet, wherein at least one RUM of the plurality of RUMs is cached at one or more locations, and wherein the application is executable such that the at least one RUM is runnable closer to a client.

The present invention provides a database coupled to a main server, wherein main server is coupled to an Internet, wherein the database comprises a plurality of database portions, wherein at least one database portion of the plurality of portions is cached at one or more locations, and wherein the one or more locations are closer to a client.

The present invention provides a system of communication, said system comprising a channel architecture having at least one channel path, wherein each said channel path comprises N channels denoted as C₁, C₂, . . . , C_{N-1}, C_{N} in a hierarchical structure of /C₁/C₂/ . . . /C_{N-1}/C_{N}, wherein N is at least 2, C₁ is a root channel, wherein Cₙ is a subchannel having Cₙ₋₁ as a parent for n=2,3, . . . , N, wherein Cₙ has an ontology Oₘ for m=1,2, . . . , N, and wherein O comprises all attributes included in Oᵢ₋₁ for i=2,3, . . . N.

The present invention provides a system of communication over a distributed processing network, said system comprising:

the distributed processing network having a plurality of nodes, wherein each node is coupleable to an Internet, wherein a main server is coupled to the Internet, wherein an application is coupled to the main server, wherein each node comprises network server, a Distributed Working Environment for Application Processing (DWEAP) for execution of a runnable module (RUM) of the application, and an application module cache for caching the RUM; and

a channel architecture having at least one channel path, wherein each said channel path comprises N channels denoted as C₁, C₂, . . . , C_{N-1}, C_{N} in a hierarchical structure of /C₁/C₂/ . . . /C_{N-1}/C_{N}, wherein N is at least 2, C₁ is a root channel, wherein Cₙ is a subchannel having Cₙ₋₁ as a parent for n=2,3, . . . , N, wherein Cₙ has an ontology Oₘ for m=1,2, . . . , N, and wherein O comprises all attributes included in Oᵢ₋₁ for i=2,3, . . . N, and wherein the processing network uses the channel architecture to transfer the RUMs from the main server to the DWEAPs.

The present invention provides a subscription structure, comprising:

a first channel;

a second channel to which the first channel is subscribed; and

a component in the first channel, wherein the component is intended to be transported from the first channel to the second channel, wherein the component intended to deliver at least one attribute to the second channel, and wherein the channel determines the at least one attribute.

The present invention provides a two-way nodal communication network, comprising:

a first node;

a second node, wherein an object O may be sent from the first node to the second node or from the second node to the first node, wherein the first node or receives O in a form F₁, and wherein the second node sends or receives O in a form F₂; and

a transport strategy, wherein if O is sent from the first node to the second then the transport strategy converts O from F₁ into a common form after O is sent by the first node and the transport strategy subsequently converts O from the common form into F₂ prior to O being received by the second node, and wherein O is sent from the second node to the first node then the transport strategy O from F₂ into the common form after O is sent by the second node and the transport strategy subsequently converts O from the common form into F₁ prior O being received by the first node.

The present invention increases the rate information transfer in response to a client request. The present invention also enables a server to serve the ever expanding numbers of clients and associated users.

### BRIEF DESCRIPTION OF DRAWINGS

FIG. 1 depicts a distributed network of computers on the Internet based on a client-server model, in accordance with the related art.

FIG. 2 depicts a distributed network of computers, in accordance with embodiments of the present invention.

FIG. 3 depicts an Internet-based globally, distributed network for a distributed processing and database system, in accordance with embodiments of the present invention.

FIG. 4 depicts a multiple root channel structure, in accordance with embodiments of the present invention.

FIG. 5 depicts an attribute-inheritance hierarchy of a channel path structure, in accordance with embodiments of the present invention.

FIG. 6 depicts an exemplary subchannel architecture, in accordance with embodiments of the present invention.

FIG. 7 depicts an application of the attribute-inheritance hierarchy of FIG. 5.

FIG. 8 depicts information concerning content-cache, border execution, and messaging, in accordance with embodiments of the present invention.

FIG. 9 depicts a MarketBus Network, in accordance with embodiments of the present invention.

FIG. 10 depicts a subscription having new components posted by a user to a target channel, in accordance with embodiments of the present invention.

FIG. 11 depicts subscription filtering and channel filtering, in accordance with embodiments of the present invention.

FIG. 12 depicts channel/subscriber authentication, in accordance with embodiments of the present invention.

FIGS. 13-14 depict executable subchannels, in accordance with embodiments the present invention.

FIGS. 15-17 depict message propagation, in accordance with embodiments of the present invention.

FIG. 18 depicts subscriptions, in accordance with embodiments of the present invention.

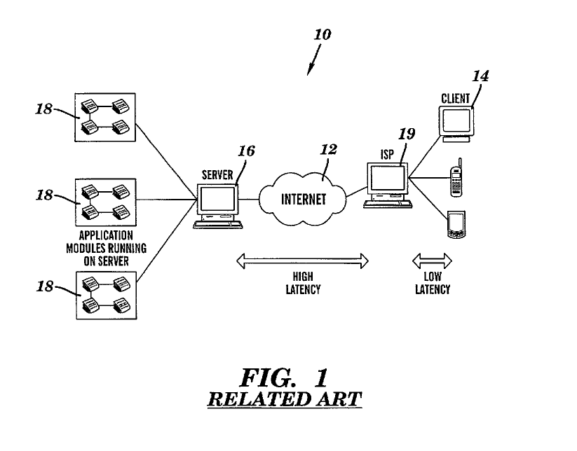

### DETAILED DESCRIPTION

The present invention discloses a system and method for disparate systems to communicate with each other. Aspects of the present invention include: 1) distributed processing; 2) systems, channels, and components; 3) the MarketBus Network; 4) two-way communication; 5) transportation protocols; 6) meta data; 7) subscriptions; 8) and authentication. There preceding aspects, as well as examples, are presented as follows.

Distributed Processing

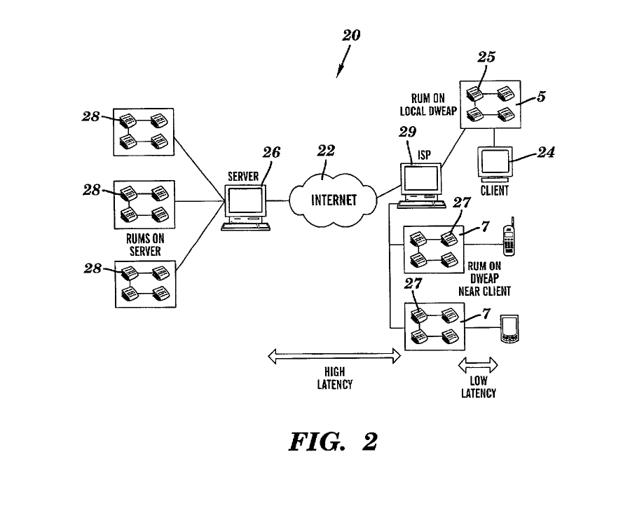

FIG. 2 depicts a nodally distributed network 20 of computers, in accordance preferred embodiments of the present invention. A client 24 is coupled to a server 26 though an ISP (i.e., Internet Service Provider) 29 and an Internet 22. In the client 24 communicates directly with the ISP 29, and the ISP 29 may communicate with the server 26 through an intervening Internet 22.

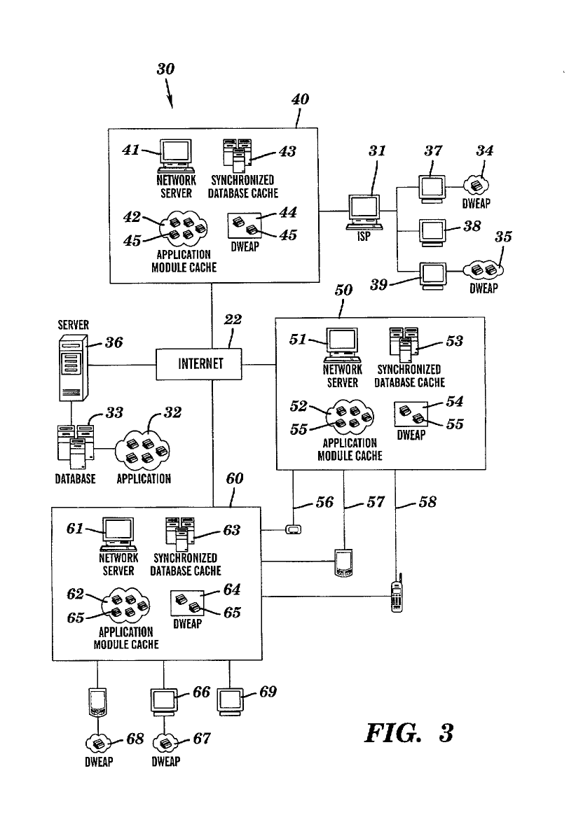

The distributed network 20 is a distributed processing system which can runnable modules at various nodes (i.e., locations) throughout the distributed network 20. An application can be broken down into the smaller, Runnable (RUMs) that are distributed throughout the distributed network 20. The present invention includes local work environments for distributed application RUMs to executed on any system near the client 24 or on the client 24 itself. These work environments are called DWEAPs: Distributed Working Environment for Processing. Application modules that would otherwise run on the server 26 may alternatively run as RUMs in the DWEAP environment. FIG. 2 illustrates 3 types of RUMs depending on their location: RUMs 28 running or runnable on the server RUMs 25 running or runnable “on the client” 24, and RUMs 27 running or runnable “near the client” 24. “On the client” 24 means on a local DWEAP 5 that is directly coupled to the client 24 with no intervening Internet 22 or ISP 29 between the 24 and the local DWEAP 5, as shown in FIG. 2. “Near the client” 24 means on a DWEAP 7 that is indirectly coupled to the client 24 with no intervening Internet 22 between the client 24 and the DWEAP 7, as shown in FIG. 2. In FIG. 2, the DWEAP 7 indirectly coupled to the client 24, because the ISP 29 is intervening between the client 24 and the DWEAP 7. RUMs running or runnable on or near the client 24 are said to be running or runnable “closer to the point of use” or “closer to the client” “closer to the edge.” This distributed processing system of RUMs enables parts of the application, namely the RUMs 25 and 27 running or runnable on the client 24 near the client 24, respectively, to be running or runnable closer to their point of use and yet maintain their collective unity. With the consequential reduced the application using the RUMs of the distributed processing system of FIG. 2 are executed faster than if all of the applications modules were executed at the 26. As will be shown infra in FIG. 3, a DWEAP may be within a node of a distributed network, wherein the node includes an application cache for caching a RUM to be executed on the DWEAP. Such an application cache is thus coupled to the DWEAP. Such an application cache may be coupled to the DWEAP such that the RUM may said to be cached on the DWEAP. Generally, the DWEAP 5 is coupleable to the ISP since at any given time the DWEAP 5 is or is not actually coupled to the ISP 29; at any given time, the coupling mechanism between the DWEAP 5 and the ISP 29 either enabled or disabled. Similarly, the DWEAP 7 is coupleable to the ISP 29.

As a consequence of the distributed processing system of RUMs, bandwidth requirements and resource requirements on the server 26 are reduced. Although there is a high latency introduced by the Internet 22 for running RUMs 28 on the server 26, there is a relatively low latency for running RUMs 25 on the client 24 or for running RUMs 27 near the client 24; i.e., there is a relatively small delay in communication between the client 24 and the RUMs 25 or 27. The RUMs also reduce the bandwidth requirements at the server 26 as the messages going back the server 26 are greatly reduced. The resource requirements at the server 26 are also greatly attenuated as the responsibility of processing is delegated to any capable device (e.g., the DWEAPs 25 and 27) closer to the client.

The present invention enables every device (e.g., clients, ISPs, etc.) to create an environment for local processing of distributed applications without affecting the look and feel or the functionality of the application. The present invention allows applications to be broken down into smaller components, namely the RUMs, such that the RUMs are locally distributed and running or runnable on the client 24 or near the client 24 wherever there is an environment (e.g., a DWEAP) capable of executing the module. Additionally, a module running or runnable on or near the client 24 can seamlessly talk to modules running on the server 26 by using the Internet 22. Thus, the present invention exploits local processing of modules for purposes of efficiency, and exploits communication across the Internet 22 the application must run a module that is not locally available. Since the as a whole functions the same as if the application were within one integrated system, communication between modules of the application is seamless.

As an example of how undesirable latency may be avoided with the present invention, consider a shopping cart application for purchasing books. Adding and removing items to the shopping cart may have relevance only locally. Add and remove operations can take place locally on the client, or at a point closer to the client, while the only message that needs to be relayed back to the server is during checkout. If 10 books are added to the shopping cart and then 8 books are subsequently removed, then the server would need to receive just one message about the 2 remaining books intended for purchase, rather than 18 messages comprising only 2 relevant messages. Thus, moving processing closer to the client more efficient than is processing by a centralized, non-distributed processing scheme at the server, and saves bandwidth as well as conserves resource at the server.

The distributed processing of the present invention also distributes risk associated with a single point of failure at the server. With centralized, non-distributed processing at the server, if the server crashes, or if any point in the logical path between the server and the client fails, then all clients using the same server would suffer disruption of service from the server. With the distributed processing of the present invention such that a given application is cached on or near the client, each client would run the given application on or near the client instead of on the server, so that a local failure on or near a given client would not disrupt an ability of other clients to run the given application.

Additionally, the distributed processing of the present invention enables the client to fully utilize the high bandwidth connection to the ISP. In contrast, centralized, non-distributed processing at the server limits overall processing so that the high bandwidth connection from the client to the ISP cannot be fully utilized.

In order to enable entire applications to be distributed to points closer to the point of use, the present invention caches relevant data near the point of use; i.e., on or near the server 24. Accordingly, the present invention provides a globally distributed network, wherein the globally distributed network comprises a synchronized database. The globally distributed network further comprises the distributed processing system that includes the DWEAPS to enable RUMs as well server side objects (i.e., data objects such as data files) to be processed closer to point of use. This globally synchronized database, together with the RUMs in the DWEAP framework, enables distributed processing closer to the point of use reduces: the latency of application throughput, server bandwidth, and server resource requirements.

The present invention structures the globally distributed network (“Network”) with nodes such that each node has access to a distributed database cache Each database cache of the cache network is synchronized with relevant data (i.e., corresponding data) from a main database of the application in real time. When the relevant data synchronized with the database is cached, any application can read operations as though the read operations were happening at the server itself. Write operations that perform critical operations or write operation for real time are handled at the main database server (e.g., the server 26).

The nodes of the globally distributed network include DWEAPs where modules can be processed. The node will provide a standard Java™Virtual (JVM) that is Java 2 Enterprise Edition (J2EE) compliant. As Java technology changes over time, more JVM can be supported. Application modules will be executed in the JVM that corresponds to the application modules. The support of Practical and Report Language (PERL), Common Gateway Interface (CGI) etc., is a little more complex due to variations in library locations and operating system dependent commands. Applications wanting to move their modules to a point closer to the client can adopt a prescribed location of libraries. The applications also have the option of creating modules that run or are runnable either on the client itself (assuming the client has the environment appropriate for running said modules) or at another point closer to the client (e.g., near the client) where the appropriate environment can be found. The present invention provides an efficient system and method to move static objects (e.g., applications or RUMs) closer to the client and distribute the responsibility of processing to almost any device on the Internet. As result, bandwidth and resource requirements on the main servers are significantly reduced.

FIG. 3 depicts an Internet-based globally distributed network (“Network”) 30 a distributed processing and database system, in accordance with embodiments of the present invention. The Network 30 comprises nodes 40, 50, and 60, each node coupled to the Internet 22. FIG. 3 also depicts a server 36 coupled to the Internet 22, a database 33 coupled to the server 36, and an application 32 to the database 33. The application 32 may also be coupled directly to the server in a manner similar to the coupling of the RUMs 28 to the server 26 in FIG. 2. FIG. further depicts an ISP 31 coupled to the node 40, clients 37, 38, and 39 each coupled to the ISP 31, DWEAP 34 coupled to the client 37, and DWEAP 35 coupled to the client 39. Generally, the node 40 is coupleable to the Internet 22, since at any given time the node 40 is or is not actually coupled to the Internet 22; i.e., at any given time, the coupling mechanism between the node 40 and the Internet 22 either enabled or disabled. Similarly, the nodes 40 and 60 are each coupleable to Internet 22.

Returning to FIG. 3, the node 40 comprises a Network server 41, an module cache 42, a synchronized database cache 43, and a DWEAP 44. RUMs 45 are shown both on the application module cache 42 and on the DWEAP 44. The node 50 comprises a Network server 51, an application module cache 52, a synchronized database cache 53, and a DWEAP 54. RUMs 55 are shown both on application module cache 52 and on the DWEAP 54. The node 60 comprises a Network server 61, an application module cache 62, a synchronized database 63, and a DWEAP 64. RUMs 65 are shown both on the application module cache and on the DWEAP 64. Clients 69 and 66 are each coupled to the node 60, 67 is coupled to the client 66, and DWEAP 68 is coupled to the node 60. Any two nodes may be coupled to each other; e.g., FIG. 3 shows the nodes 50 and 60 coupled to each other by one or more of coupling lines 56, 57, and 58.

In FIG. 3, the application 32 in conjunction with the database 33 would conventionally run on the server 36, and communication between a client and the server 36 in relation to the application 32 would be across the Internet 22 with an associated high latency introduced by the Internet 22. With the present invention, however, any of the clients 37, 38, and 39 may elect to communicate with the 40 through the ISP 31, to cause the node 40 to execute the application 32 in conjunction with the database 33, which could be accomplished with a relatively latency because said execution at the node 40 is near the client 37, 38, or 39 thus closer to the client 37, 38, or 39 as compared with execution on the server 36. The Network server 41 would cache the application 32 as a RUM in the node 40; e.g., in the application module cache 42 of the node 40. Additionally, Network server 41 would cache the database 33 in the network node 40; e.g., in synchronized database cache 43 of the node 40. With said caching in place, the Network server 40 would utilize the DWEAP 44 to locally execute the application in conjunction with the database 33 at the relatively low latency.

The preceding example of using the node 40 to execute the application 32 in conjunction with the database 33 closer to the client 37, 38, or 39 is merely one many possible embodiments. As another example, the application 32 may be run the client 37 at a local DWEAP 34, or on the client 39 at a local DWEAP 35. Generally, the application 32 may be broken down into a plurality of RUMS to be executed on a plurality of nodes, or on the client 37, 38, or 39 itself and on at one node near the client 37, 38, or 39. Also note that a client may be coupled directly to a node without an intervening ISP, such as the clients 69 and 66 which each directly coupled to the node 60. As another example of distributed the application 32 in conjunction with the database 33 could be executed on both nodes 60 and 50 in light of the coupling lines 56, 57, and 58 between the nodes 60 and 50. With use of nodes 60 and 50, the application 32 would be broken into: first RUMs cached on the application module cache 62 of the node 60, and second RUMs cached on the application module cache 52 of the node 50. the database 33 would be broken down into: a first database portion cached on synchronized database cache 63 of the node 60, and a second database portion cached on the synchronized database cache 53 of the node 50. The Network 61 would execute the first RUMs with the first database portion on the DWEAP 64, and the Network server 57 would execute second RUMs with the second database portion on the DWEAP 54. Any other variation of distributed processing of the application 32 in conjunction with the database 33, using nodes of the Network to execute the application 32 closer to the client, is within the scope of the present invention.

Systems, Channels, and Components

Any business or system can be represented as a set of functional subsystems, called channels, such that each subsystem or channel performs a defined function. Definitionally, a channel is a logical representation of a container that hosts static content (e., downloadable files, graphics files, etc.) and executable components (e.g., executable modules) as well as receives messages pertaining to the channel. Since a channel has a defined function or purpose, each channel: must know its function; must know what it can and cannot do; and must know what it can and cannot talk about. The defined function or purpose of each channel is defined in ontology of each channel. The ontology of the channel is the language of the channel and defines the purpose of a channel. The ontology represents the attributes that any message posted to the channel must implement. For example, the ontology defines what objects or components can reside in this channel, what messages the channel can receive, and how to make sense of these messages. the ontology defines the purpose and properties of communication, such purpose and properties can also be agreed upon by clients or users. A strength of this methodology is that one can create these channels as required on the fly using whatever protocol the system is using. See infra section entitled “Transportation Protocols” for a discussion of protocol independence. This methodology provides enough flexibility in terms of dynamic creation and handling of channels that it easily be adapted to changing technologies and business needs. An ability to channels with defined purposes also enables applications to be viewed as a collection of modules. An ability of these modules to interact seamlessly enables internal and external systems of modules to appear as one unified system to their users.

Components are of various types, including content objects (e.g., files, messages, etc.), executable modules, and channels (i.e., a channel is a special type of component as will be discussed infra). Components can move around in the system and be delivered as needed to their point of use. The applications are abstracted from the implementation of the channels. The user and the can treat channels to be like directories although their actual implementation vary. In summary, every system can be viewed as components residing in a set of channels that have a defined ontology. No matter what the function of a system, first system can communicate with a second system if there is a defined purpose the communication (i.e., a defined ontology) and if there exists a channel for the communication between the first and the second system.

All static components, regardless of type, reside inside channels and all executable modules are also represented as channels. Thus as an outcome of the distributed processing of the present invention, there is a unified means of dealing with static content, dynamic content, and executable modules. All objects that inside a channel are treated as unified components. Executable components are distributed throughout the Network as though they were just static content. Rather than fetching, static content calls to executable components result in a message containing the result of the process (i.e., the static content calls).

An executable component can rest in an executable channel that is treated just like any other channel housing static content. The executable channel or interface is unique kind of channel, because it refers to a method call in a Module (RUM). As discussed supra, a RUM is a functional sub system of an application that can be distributed through a network and executed at a point to its use. The executable interface may or may not store the actual RUM, but the ontology of the channel describes the parameters of the method. In order to run specific method, the channel must also know the location and name of the RUM well as the method to call within the RUM, which is contained in meta data for the executable channel. See infra section entitled “Meta Data” for a discussion of meta data.

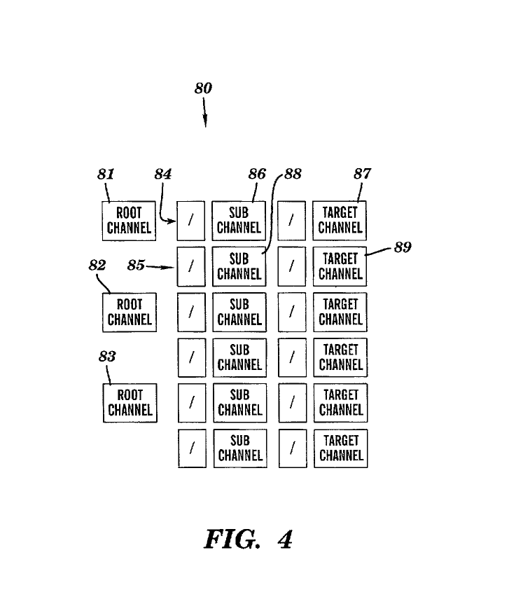

FIG. 4 depicts a channel architecture 80 having a multiple root channels 81, and 83, each such root channel forms its own hierarchal tree. Every root channel forms the basis of a single system having subchannel paths such that each subchannel path includes one or more subchannels. A terminating subchannel of subchannel path is called a target channel. For example the root channel 81 has subchannel paths 84 and 85. The subchannel path 84 includes subchannels 86 87, wherein the subchannel 87 is a target channel. The subchannel path 85 subchannels 88 and 89, wherein the subchannel 89 is a target channel. Similarly, the root channels 82 and 83 each have subchannel paths and associated subchannels, as may be seen in FIG. 4. Note that the target channel 87 is “downstream” from the subchannel 86 in the subchannel path 84, and the target channel 89 is “downstream” from the subchannel 88 in the subchannel path 85. Generally, of two subchannels in a subchannel path, the subchannel furthest from the root channel is said to be “downstream” from the other channel; additionally each of the two channels is “downstream” from the root channel.

Since all subchannels are further specializations on the definition of the root channel, the root channel can be considered as the foundation of a single system. The system, as implemented on the MarketBus (discussed infra), is expressed as set of all channel definitions and their relationships. Interactions between can be expressed as subscriptions between uniquely rooted branches.

Based on FIG. 4, all components can be addressed directly thru a fully qualified path that follows the form:

/<root-channel-name>/<fully-qualified-path>/<target-component>.

The <target-component>, or target channel, is positioned “downstream” from all other subchannels in the fully qualified path. A channel is a special kind of component and can be addressed directly as if it were a component of it's parent channel. A channel must have a parent, and exist within its parent channel, with exception of a root channel. A user addresses the target channel via the fully qualified path-name that includes all of the target's parent-channels, similar to a directory tree. In this way, requests for components, or requests directly to a channel, follow the same addressing syntax. The aforementioned path form a unified addressing scheme to locate and act upon typed objects as either content or as an interface to functionality. Thus, a user and applications can treat channels to be like directories, even though their actual implementation might vary. The applications are abstracted from the implementation of the channels.

FIG. 6 depicts an exemplary channel architecture 150 which illustrates parent channels and subchannels. In FIG. 6, a root channel “/QNN” relates to a television station QNN. The root channel “/QNN” has a subchannel “/QNN/News” 152. The subchannel “/QNN/News” 152 is a parent channel of subchannels “/QNN/News/Politics” 153 and “/QNN/News/Sports” 154. The subchannel “/QNN/News/Sports” 154 is a parent channel of subchannels “/QNN/News/Sports/Football” 155 and “/QNN/News/Sports/Baseball” 156. Since each channel has an ontology associated with it, the subchannels must also have ontology, and the subchannels must implement all attributes of the parent Thus the “/QNN/News/Sports/Football” 155 channel must implement all attributes of the parent channel “/QNN/News/Sports” 154. If the channel 154 has attributes 161 of Title and Date in its ontology, then any of its must at the very least have the attributes Title and Date, which are called attributes”. Thus, the attributes Title and Date are inherited attributes for the subchannel “/QNN/News/Sports/Football” 155. The subchannels can add to the ontology of the parent and make it more specific. Accordingly, the subchannel “/QNN/News/Sports/Football” 155 has the attributes 162 of Title, Date, and Body Text, which includes the added attribute of Body Text. Similarly, the “/QNN/News/Sports/Baseball” 155 has the attributes 163 of Title, Date, and which includes the added attribute of Team.

A channel manages components and every component must exist within a channel. Conversely, within any channel are components. A component cannot within multiple channels at the same time. A channel specifies the type of component that the channel can manage, and a channel can only manage a single component type. A component is singular and unique, and is of a specific type having attributes. A component may only post to a channel if the channel has defined attributes for the component. A component must contain a complete set of the attributes defined for a channel. Component attributes may include, inter alia: expiration time, quality of service, source, name, globally unique identifier, and access control list.

A component may possess an expiration time. Components are persistent and remain within a channel until the expiration time. Persistent components may be destroyed or updated at any time. Components that have an expiration-time of are considered real-time and will be delivered only to those clients that are subscribed to the channel.

Quality of service properties may be applied on a channel-by-channel basis. quality of service properties are applied to all components within the channel. The quality of service properties can dictate the priority of component delivery and how the network should handle traffic related to a component.

All components are posted from somewhere and thus have a source. In many cases these components are obtained either thru a subscription, or from a subchannel. All components indicate their source. As a result, subscriptions can determine the context of an event or message.

All components must be given a name that is unique within their channel, enables the components to be addressed.

Every component within the MarketBus (to be discussed infra) is assigned a globally unique identifier (GUID) that enables the component to be addressed directly.

Every component has an owner. The owner is referenced during access control checks. The owner is encoded as a GUID. In this way, a component may own other components directly. The owner is used for accounting information.

A channel or component may have an access control list, which specifies who may access the channel or component. Each channel and component has a GUID can be used during security checks.

Channels are not just component repositories. Components within a channel also be thought of as messages. Any client-user or component may subscribe to a channel. By subscribing to a channel, a client is declaring which component-types the client is interested in, and also what attributes of that component type the is interested in. When a component is posted to the channel, the client receives those attributes of the component the client is interested in. As a message, a component may be delivered in realtime to anyone who is subscribed to that component's channel. Components may serve to notify the subscriber of any event, including information about the channel or other objects. Components can as realtime messages and may carry any type of data. As such, components may function to stream data to a client. For example, a channel may function as a realtime video stream. Messages may also be executable objects and deliver logic a subscriber for execution. Messages may also carry functional information multiple executable objects. As such, objects can represent a public interface of an executable or java class object.

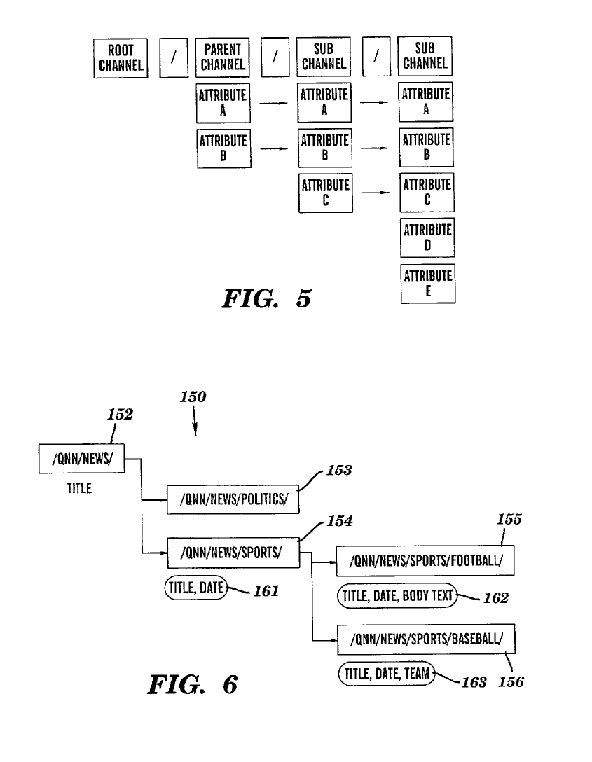

As discussed supra in conjunction with FIG. 4, a channel can have subchannels, which can be thought of as specializations of the parent type, or as extensions on the parent type. A subchannel must include all of the attributes of it's parent illustrated in FIG. 5. If a component is posted to a channel, and the target channel not a root-channel, all parent channels also receive the component. The converse not true; subchannels do not receive objects which are posted directly to their parents. Thus, any message posted to a channel is automatically posted to the channel's parents. All subchannels must implement all of the attributes of a parent channel. Since all attributes of a parent channel must be inherited by the parent's subchannel, the parent channel also understands any message that is posted to its subchannel. The messages received by a subchannel are thus automatically passed upstream to the parent channels of the subchannel. As designed, subchannels can be considered as derived classes of their parent channels. Because all subchannel types implement the parent's types, the parent channel can always generalize and understand components that exist beneath them in the addressing tree.

Since each channel has an ontology associated with it, the subchannels must also have an ontology. Subchannels must implement all attributes of the parent channel. For example, if a given channel has attributes “Title” and “Date” in its ontology, then any subchannels of the given channel must at the very least have attributes “Title” and “Date.” Such attributes are called inherited attributes.

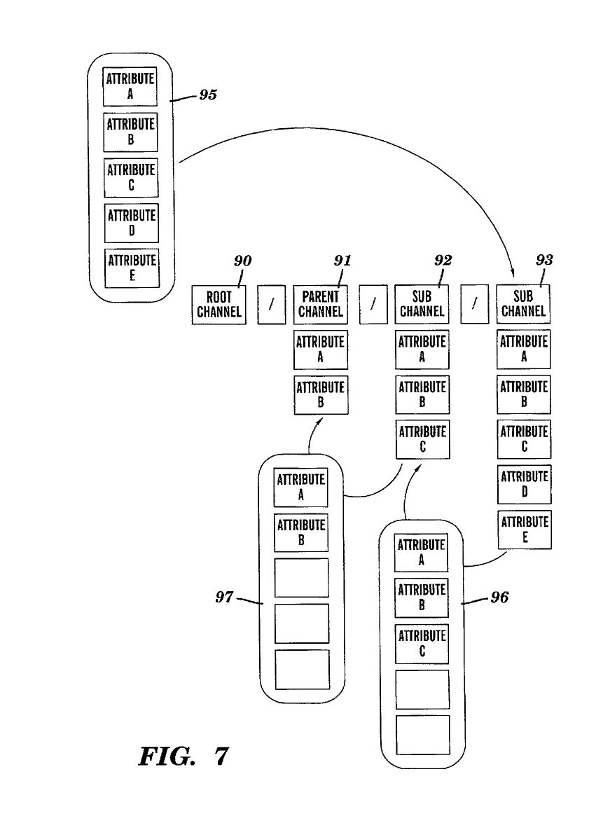

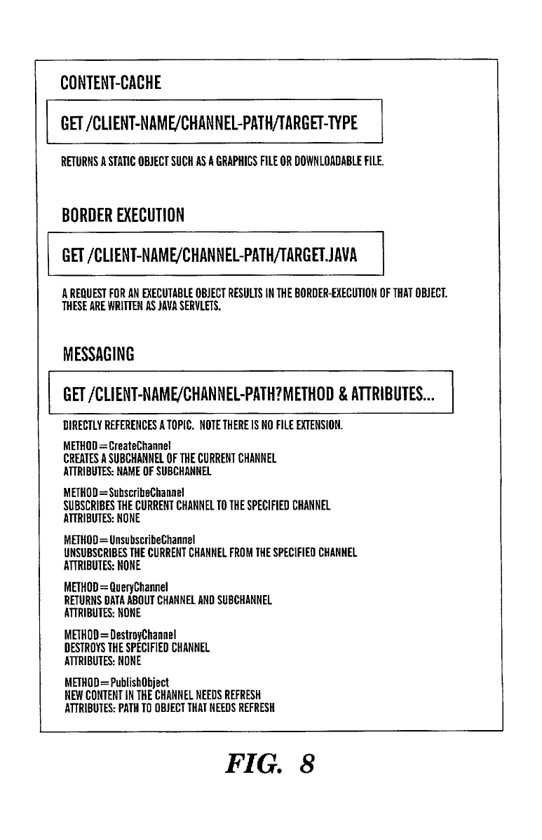

As an example of the attribute-inheritance hierarchy of FIG. 5, FIG. 7 depicts a root channel 90 having a hierarchical path of: subchannel 91, subchannel 92, and subchannel 93, wherein the subchannel 91 is a parent of the subchannel 92, and wherein the subchannel 92 is a parent of the subchannel 93. A message 95, attributes A, B, C, D, and E, has been posted to the subchannel 93. A subsequent message 96 becomes available to the parent channel 92 of the subchannel 93, the message 96 includes only a portion of the attributes (i.e., attributes A, B, and of the previous message 95, as defined by the attribute-inheritance hierarchy. A subsequent message 97 becomes available to the parent channel 91 of the subchannel 92, and the message 97 includes only a portion of the attributes (i.e., attributes A and B) of the previous message 96, as defined by the attribute-inheritance hierarchy.

FIG. 8 discloses information concerning content-cache, border execution, and messaging.

The MarketBus Network

A MarketBus Network (“MarketBus”) of the present invention includes a for obtaining a single unified set of channels which deliver and house objects of all types and include the capability of executing logical objects. The MarketBus each MarketBus router, and each client of the network interacts with a subset of a global channel database. The global channel database is available to any client or router in the network, but the router will manage and interact with only those channels that are currently relevant. The MarketBus enables interaction with a of a globally distributed datastream while retaining the meaning and function of interaction in relation to the global data set.

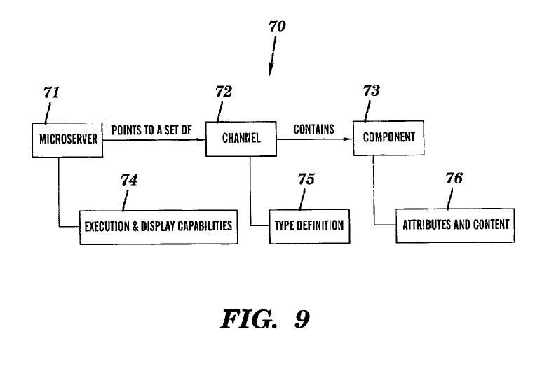

FIG. 9 depicts a MarketBus Network 70 which has three main object types: microserver 71, channel 72, and component 73. The MarketBus includes the microserver 71 (or a collection thereof), which is an execution environment that execution and display capabilities 74, to communicate with and execute logic on behalf of a global real-time distributed communication medium that is organized into channels. The microserver 71 functions to interact with a subset of the global channel database. The microserver 71 may interact with any number of channels such as the channel 72, as well as create or destroy channels. The microserver 71 can subscribe to channels and thus collect all information within those channels time. The channel 72 specifies the type 75 of component that the channel 72 can manage. The channel 72 can only manage a single component type. The 73 has attributes and content 76. In accordance with the prior discussion in the context of FIG. 9, the MarketBus includes: a microserver which implements a architecture of the present invention; and distributed module execution environments (e.g., DWEAPs) which run executable components and provide caching capabilities as well as database caching capabilities.

The MarketBus Network manages many types of components. All components can be addressed directly thru a fully qualified path as discussed supra in conjunction with FIG. 4. The MarketBus provides a unified addressing scheme to locate and act upon typed objects as either content or as an interface to functionality. The system, as implemented on the MarketBus, is expressed as the of all channel definitions and their relationships.

The MarketBus enables static and executable objects to be delivered in realtime as messages to a custom execution environment of the microserver. As such, MarketBus enables any custom content type or logical type to be interpreted or executed within a custom environment.

The MarketBus can not only deliver content in a distributed fashion but also do distributed processing. This allows applications to be broken down it modules, of which can be moved closer to the client and all processing for these modules happens in this distributed environment closer to the point of use. Another advantage of using this distributed processing module scheme is that it allows databases to be distributed as well. Replicas of the database can be setup in a distributed network that are accessible at these distributed processing locations. Thus even dynamic content (i.e., content that changes), in addition to static can be delivered in a distributed fashion.

The MarketBus is not only enables distributed content and processing technology, but also helps enterprise systems seamlessly talk to other system and outside the MarketBus system. The MarketBus allows different systems that hitherto had no effective means to communicate with each other to act as one unified system. When a book is purchased from a distributor, not only does the distributor's billing department get the information concerning the book purchase, but the same information can be communicated to the publisher of the book as and also to a shipper such as FedEx®. Although each of these different systems talks a different language and runs on a different platform, these different can still make sense of the aforementioned communication within their own

The MarketBus facilitates marketing of finely grained application services by software application vendors. Software companies often times want to sell not only applications, but also application components that provide a subset of the application's services. Today these are usually packaged as libraries and linked at compile-time. With technology such as Distributed Component Object Model (DCOM) and Common Object Request Broker Architecture (CORBA), an effort is made to allow these ‘pieces’ of an application to be distributed and used at run-time. Today on the Internet, implementing remote library calls becomes problematic as the distance between components increases. Applications are rendered useless if the collaborating components must be transported over the Internet backbone. The MarketBus addresses this problem in a unique way by providing a localized environment where all components may interact. The message-bus provides a standard, cross-platform medium thru which executable components may interact. The end result is that the MarketBus becomes an enabler technology for not only online application themselves, but also finely-grained application-internal services. It is conceivable that vendors may provide rich of functions for use by other application vendors. An example might be a 3D-graphics rendering library provided by a library vendor, exposed over the A consumer-level graphics application vendor may utilize this 3-D library on the back-end of his application, saving his own development time. The library vendor would charge the application vendor for services rendered, and the application vendor would charge the end user. The MarketBus provider would charge both the application vendor and the library vendor for resources consumed.

The MarketBus technology allows enterprises to continue to use their current applications which are written in older languages and run in older operating systems, and move components or portions thereof that are better suited for processing with newer languages (e.g., Java) and systems. Thus MarketBus resources, since a conversion of all applications into Java may be a mammoth, expensive task that is often not even possible due to performance reasons. Since processing in the MarketBus system can happen on any capable device, these components need not be just Java components catered to be served and processed at the Market Bus servers. Components can be served at just about any capable processing device.

Two-Way Communication

The Internet today, primarily provides one-way communication. A client a web page and the browser displays the requested page, based on a simple request-response model in which the client requests and the central server responds. In contrast, the present invention discloses a global microserver that enables every device to engage in two-way communication in which every node on the Internet may act both as a sender as well as a receiver of information Since the distributed processing of the present invention enables every node on the Internet execute modules, such nodes should not only have the ability to send information but should also be able to receive information; i.e., such two-way communication natural to distributed processing of the present invention. Thus, the present invention replaces the simple request-response model with a two-way subscriber-publisher model.

For example, an aspect of the Internet can be imagined to be a voicemail that is called for receiving messages. Accessing xxxyyyy.com to get a message is like dialing 1-800-xxxyyyy to receive voicemail. There are applications, where one might want to be informed of events that happen in the world, such informed of when a stock reaches a predetermined stock price, if a specified flight delayed, if a little league baseball match gets rained out, etc. Thus, the present invention enables this voicemail system of the Internet (i.e., a node) to initiate such desired communication, and enables any channel to not only send information to another channel but also receive information from the other channel. See infra for discussion of “channels.” Accordingly, the present invention enables the publisher model to effectuate seamless interaction between systems and thereby facilitates distributed processing of application modules executed by these

Transportation Protocols

Transport Strategy Hubs for Internet Protocols (“TSHIP”) act as a gateway for abstracting (i.e., insulating) applications from transportation protocols in a manner that enables the applications to send messages using their original Internet Protocols and receive messages using their original Internet Standard Protocols. In abstracting applications from such transportation protocols, TSHIP converts Internet protocol messages into a Common Channels and Component (C3) Form subsequently converts messages in the C3 Form back into the standard Internet protocols. Thus, TSHIP insulates applications from future changes in technology, such as: new or changed operating systems, new or changed protocols which are faster and more reliable, an increasing number of platforms and devices, new or changed software languages (e.g., Java), etc. Accordingly, TSHIP allows systems to communicate seamlessly with MarketBus in terms of channels and components, using the same ontology, even if there are differences in how the channels and components are represented physically. Thus, TSHIPs are a gateway for messages moving into and out of the MarketBus, and the TSHIPs enable systems to communicate about channels and components independent of what protocol the systems independently use for such communication. Accordingly, TSHIPs act as a transformer of data which enables systems to communicate in a protocol independent mode.

With TSHIPs, applications are totally insulated from the way the C3 Form is implemented. If a new technology evolves tomorrow, the C3 Form implementation by the MarketBus would change to utilize the strength of this technology. Although the applications would still use their original protocols, the applications would nevertheless use the strength and power of the new technology. In that manner, TSHIPs enable applications to utilize the power of new technologies without switching their original protocols of communication.

The MarketBus supports multiple transport strategies, enabling applications or users to switch between transport strategies while the applications continue to run seamlessly. As a transport strategy, TSHIPs comprise a translation layer between an outside device protocol, such as HTTP, and the internal MarketBus protocol, which enables any device to integrate with the MarketBus.

Meta Data

Every channel is associated with meta-data that is understood specifically by MarketBus. Components within a channel can specify additional meta-data that is specific to the component. The meta-data specifies how components within the channel are to be handled. The MarketBus enables globally available components have unique properties specific to their execution, logic, and deliverable The meta-data understood and identified by the MarketBus include Multi-purpose Internet Mail Extensions (MIME) types.

MIME is a specification for enhancing the capabilities of standard Internet electronic mail. Using MIME types, the MarketBus is able to determine whether to deliver an object to a client, or whether to execute the object on the client's behalf. Furthermore, clients may specify what types of components they are capable of executing, and the MarketBus may deliver executable content directly to the client for capable execution. Thus, the meta data enables the MarketBus server to act as object filter based on meta data that exists at each node of the MarketBus

The MIME types understood by MarketBus Network include: deliverable components, edge components, deliverable executable components, and channel components.

Deliverable components are content-objects that are served to the client. content-objects can be edge-cached objects such as graphics files and downloadable files. These content-objects can be messages that carry important information. A component can contain any kind of data. Components can be addressed as content, or they can be thought of as messages that are passed over channel.

Edge components are written in Java and must follow the J2EE specification for server-side Java applications. Executable components are spawned and executed locally within the MarketBus Router itself. Executable components are very flexible.

An executable component may handle a realtime stream such as RealVideo or Shoutcast Audio, or the executable component may handle an interactive program such as an E-commerce shopping cart. There are no limitations placed on the functionality of an executable component.

Deliverable executable components may be delivered to the client microserver for client-side execution. This is opposed to edge-execution on the border router. deliverable, executable object will be executed on the client-device itself. The type of executable is only limited to the capabilities of the given client microserver. the microserver may be custom or proprietary, it is possible to deliver any conceivable executable type.

Channel components are not deliverable. Channels are a special kind of component in that they are containers for other components. Channels are the principle means of communication and organization between all components the MarketBus Network. This can include client-side applications that are in communication with the MarketBus Network. Client-side users or executable components may post events and additional components into any channel. As each channel becomes a realtime communication medium as well as a component repository. Recalling that all components must have a type, the channel defines the types of components which may exist in the channel.

A channel may be designated as an interface channel, such that components within the channel are intended to be delivered to a public function exposed from executable object. The channel type is a specification of the arguments to the function. By defining an interface channel, the MarketBus Network enables mobile agents and distributed executables to expose their logical interfaces to realtime streams and events. Executable objects can respond to events in realtime.

Subscriptions

A subscription allows any channel to post messages to and receive messages from any other channel, regardless of hierarchical position. A subscription allows messages and objects to be disseminated to appropriate sub-systems as well as ability to build on a message. A subscription gives a channel the ability to extract a subset of the attributes defined for the publishing channel as well as add default values to the missing attributes required the receiving channel's ontology. When subscribing, a channel defines the attributes that the channel is interested in. The specified attributes must be valid for the channel-type. In other words, the must be defined for the channel.

A subscriber-channel can never subscribe to a component directly; instead it must subscribe only to other channels. As a result, communication between components must always take place over a specified channel. Components themselves never subscribe to channels. If a component is executable and requires notification of events within another channel, an additional channel can be created for these notifications. Specifically, an interface channel is defined for the exported function of the executable. The interface channel is then subscribed to the source and notification is thus enabled.

Since a channel can directly route messages to an executable function, it to reason that a channel defines some action, and that posting to a channel is to perform that action. By forcing executable components to subscribe to via an interface channel, the message-bus becomes intimate with the execution of it's messages.

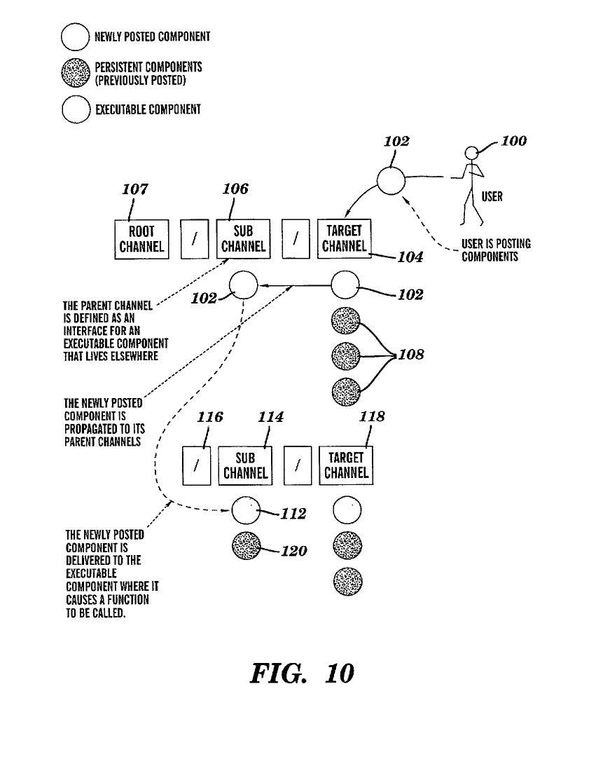

FIG. 10 illustrates subscriptions. In FIG. 10, a user 100 posts a new 102 to a target channel 104. Then the new components 102 are propagated to an interface subchannel 106, wherein the interface subchannel 106 is a parent of the target channel 104, and the interface subchannel 106 is a subchannel of a root channel 107. Persistent components 108 in the target channel 104 are not propagated to the interface subchannel 106. The new components 102 are delivered to an executable component 112 in a subchannel 114 of a root channel 116. Upon receiving the new components 102, the executable component 112 causes a function to be called. The subchannel 114 is a parent of a target channel 118, and the executable component 112 along with a persistent component 120 is inherited by the target channel 118.

A subscription will deliver the contents of one channel into another, and a subscriber is expected to understand a portion of the attributes of the channel that the subscriber is subscribed to. In every subscription the subscriber will specify which attributes to deliver. The subscription may include a “subscription filter” by itself specifying a conditional match expression that filters any such attribute against the expression. Additionally, since a subscriber channel may have that are not accounted for in the target channel, the subscription itself must default values for the attributes of the subscriber for attributes not supplied by the target of the subscription.

A channel may specify a channel filter, similar to a subscription filter, that governs which components may be posted into the channel. The channel filter will apply after all subscription filters have been applied. A client in direct communication with the channel will be subject to the channel filter. By this user requests are subject to a channel filter, and subscriptions are subject to both the subscription filter and the channel filter.

A channel may also have a logical filter which both validates a message and selectively processes only certain messages posted to it. This is a powerful option which dramatically reduces the processing of erroneous messages. The logical can either be a simple expression in terms of the attributes of a channel or even refer to another logical object. The logical objects may be represented as a set of channels and subchannels. The reason for providing this flexibility for the logical object is to enable applications to be built solely on the MarketBus. Entire applications can be built just using the channels, component, and subscription philosophy if the notion of selection message propagation is added to it. Any UML diagram or flow chart can now be converted into channels, components, subscriptions, and logical filters. Therefore any application can also be developed and deployed solely using the MarketBus. Applications still have the option of making the RUMs and deploying them using executable channels, but using the MarketBus itself to write applications makes the application completely modular, totally distributed, and enabled to run on any device at all.

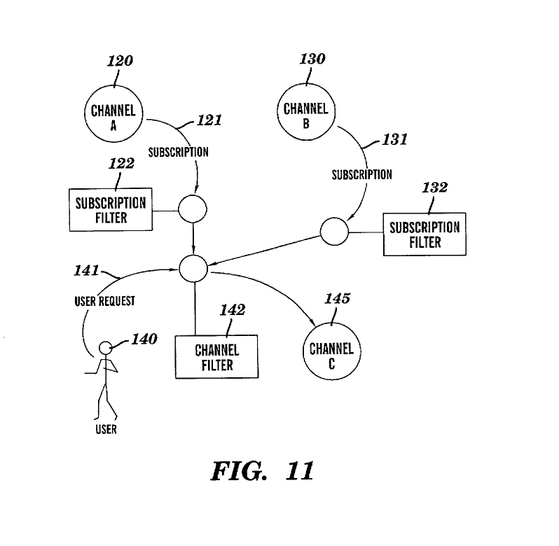

FIG. 11 illustrates subscription filtering and channel filtering. In FIG. 11, channels 120 and 130 each attempt to send components 121 and components respectively, to a channel 145. Additionally, a user 140 attempts to send components 141 to the channel 145. The components 121 are subject to the subscription filter 122 which may filter out attributes of the components 121. The components 131 are subject to the subscription filter 132 which may filter out attributes of the components 131. After passing through the subscription filters 122 and 132, the components 121 and 131 respectively pass through a channel filter 142. The components 141 also pass through the channel filter 142. The channel filter 142 may filter out components from the components 121, 131, and 141 before allowing the components 121, 131, and 141 to arrive at the channel 145.

Authentication

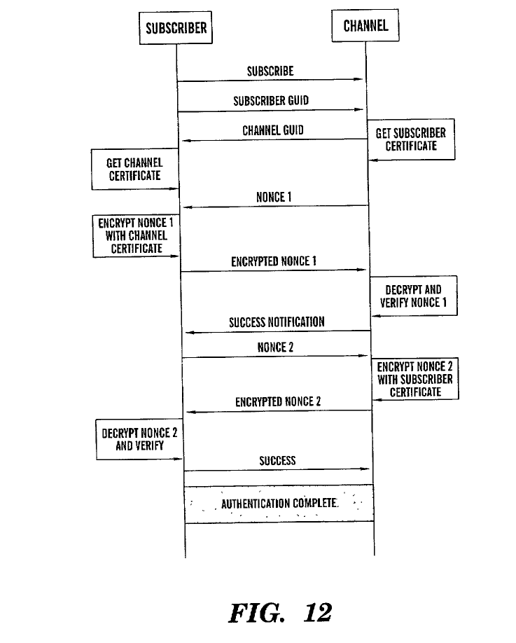

A channel may authenticate a subscriber before allowing the subscription. Conversely, the subscriber may authenticate the channel before completing the subscription. In this way, both parties to the communication are assured of the other's identity. The protocol is a standard, certificate-based authentication sequence as shown in FIG. 12. In accordance with FIG. 12, security is at the channel level. As an example, if e-mail goes on a first channel and confidential reports go a second channel, then the second channel can be made secure while the first channel is unsecure. Generally, any number of channels can be made secure. messages associated with a channel are encrypted. Reading a secure message requires decryption software and channel certification.

Illustrative Examples

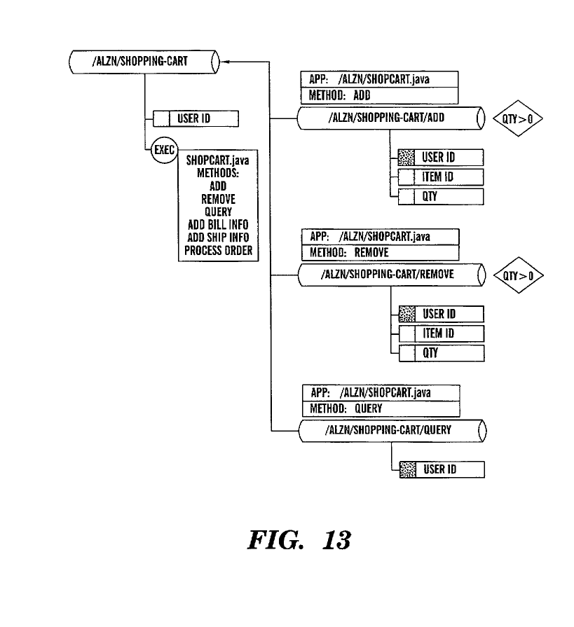

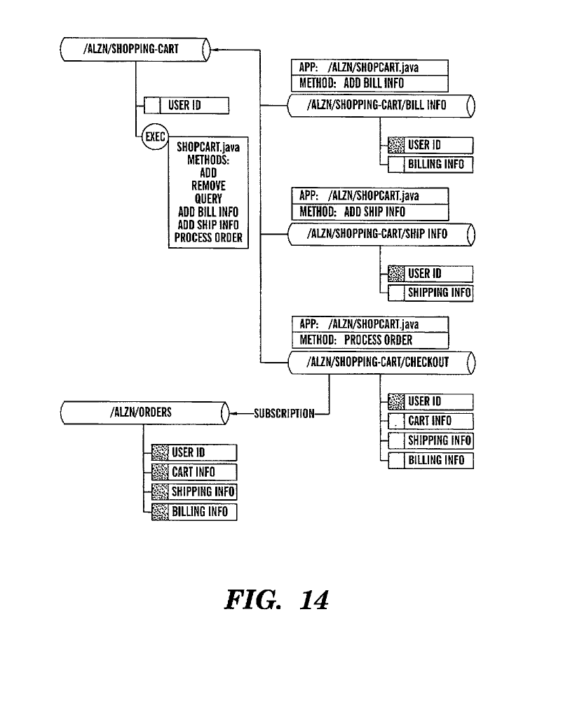

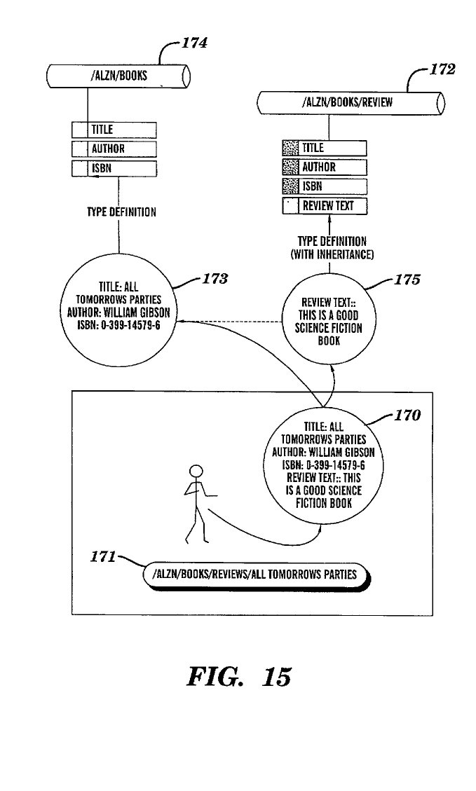

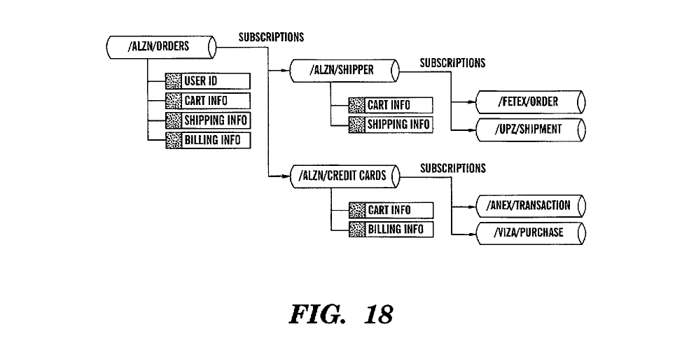

FIGS. 13-18 illustrate channels (FIGS. 13-14), message propagation (FIGS. 15-17), and subscriptions (FIG. 18). Consider a system called Alzan which is a that sells and distributes publications such as books. Assume that Alzan's business comprises: 1) book database searching and browsing; 2) shopping methods processing; and 3) inventory and order management. Book database searching and browsing lets users browse and search a book database based on title, author, and publisher information. The books may be categorized into genres, ratings etc. Shopping methods processing provide basic shopping cart functionality, such as letting users add and remove items to a shopping cart, gather billing and shipping information, and then place a final order during checkout. Inventory and order management maintains an inventory of books, processes orders, and places orders with publishers if necessary.

As applied to Alzan, the present invention caches the book database from a globally distributed network to a point closer to the point of use so that the browsing and searching functions can be implemented efficiently and seamlessly. Users performing browsing and search functions are now accommodated by the MarketBus rather than an Alzan server across the Internet. Distributed processing likewise implemented at a point closer as a result of generating a channel architecture as follows. Starting with a root channel/ALZN:

1. Create a new channel called “/ALZN/Shopping-Cart” using a syntax such as, inter alia: Create New Channel (“/ALZN”/Shopping-Cart”).

2. Define a channel ontology for “/ALZN/Shopping-Cart” which defines an attribute of User Id for “/ALZN/Shopping-Cart” sing a syntax such as, inter alia: Define Ontology (“/ALZN/Shopping-Cart”, Argument List), wherein Argument List includes User Id.

3. Add a shopping cart servlet “ShopCart.java”t o the channel Cart” using a syntax such as, inter alia: Add Component to Channel “/ALZN/Shopping-Cart”).

4. For each method that the servlet “ShopCart.java” performs, declare an executable subchannel from “/ALZN/Shopping-Cart” using a syntax such as, inter alia: Create Executable Sub Channel (Channel Name, Sub Channel Name, Method).

5. Declare an ontology for each said executable subchannel, defined supra, using a syntax such as, inter alia: Define Ontology (Channel Name, Attribute List).

6. Replicate the aforementioned channel architecture, including the and all components inside the subchannels, and send the replicated channel architecture to all distributed nodes on the Network associated with the MarketBus, using a syntax such as, inter alia: Deploy (“/ALZN/Shopping-Cart/”).

FIGS. 13 and 14 illustrate executable subchannels under parent channel “/ALZN/Shopping-Cart”. In particular, FIG. 13 illustrates the following executable channels: “/ALZN/Shopping-Cart/Add”, “/ALZN/Shopping-Cart/Remove”, and “/ALZN/Shopping-Cart/Query”. FIG. 14 illustrates the following executable “/ALZN/Shopping-Cart/Billlnfo”, “/ALZN/Shopping-Cart/Shiplnfo”, and “/ALZN/Shopping-Cart/Checkout”. The ontology of each such executable channel defines the attributes required by the method(s) employed by each such executable channel. A Message to “/ALZN/Shopping-Cart/Add” ust contain User Id, Item Id Qty, while a call to “/ALZN/Shopping-Cart/Query” need only contain the User Id. 14 also illustrates a subscription from “/ALZN/Shopping-Cart/Checkout” to a channel called /ALZN/Orders.

The following example illustrates how a message is processed by an channel. The executable channel “/ALZN/Shopping-Cart/Add” erforms, inter alia, the following tasks upon receiving a message: 1) validating if all attributes of the executable channel “/ALZN/Shopping-Cart/Add” exist in the message; 2) looking the meta data information to locate the relevant RUM (named, e.g., “Add.java”) comprising a method for implementing “Add” and 3) calling and executing the relevant RUM, using the given attributes as input parameters to the relevant RUM. The relevant RUM could reside either within, or outside of, the executable “/ALZN/Shopping-Cart/Add”.

FIGS. 15-17 illustrate message propagation, which particularly illustrates that: any message posted to a channel is automatically posted to its parents; all subchannels must implement all of the attributes of a parent channel; since all attributes of a parent channel must be inherited in the parent's subchannels, the parent channel also understands any message that is posted to its subchannel; and message received by a subchannel is automatically passed upstream to the subchannel's parent channel.

FIG. 15 depicts an object 170 placed in channel “/ALZN/Books/Review” 172, wherein the object 170 originated from a channel “/ALZN/Books/Review/All Tomorrows Parties” 171 . Note that all attributes defined by the channel “/ALZN/Books/Review” 172 (i.e., attributes Title, Author, ISBN, Review Text) must present in the object 170. The subchannel attributes is a union of all parent attributes as well as any additional attributes defined by the subchannel. Thus, the attributes Title, Author, ISBN, Review Text of the channel “/ALZN/Books/Review” is a union of the attributes Title, Author, ISBN of the parent channel 174 and the additional attribute Review Text 175 that is specific to the channel “/ALZN/Books/Review” 172. The MarketBus will automatically split the object 170 into objects 173 and 175 in accordance with the attributes of the parent channel “/ALZN/Books” 174 of the subchannel “/ALZN/Books/Review” 172. Thus the 173, which includes attributes Title, Author, ISBN (i.e., a subset of the attributes of the channel “/ALZN/Books/Review” 172) is placed into the parent channel “/ALZN/Books” 174. Note that the objects 170, 173 and 175 are each assigned a distinct Global Unique ID (GUID), which is used to address each of the objects 173 and 175 internally.

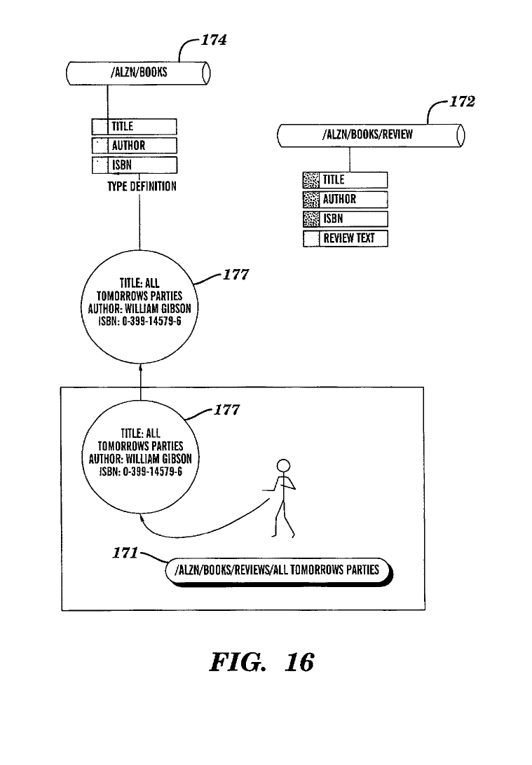

FIG. 16 illustrates the object 177 placed into the parent channel “/ALZN/Books” 174 of the subchannel “/ALZN/Books/Review” 172, wherein the object 177 originated from the channel “/ALZN/Books/Review/All Tomorrows Parties” 171. object 177 need include attributes (Title, Author, ISBN) of only the parent channel “/ALZN/Books” 174, and not of the subchannel “/ALZN/Books/Review” 172, since the object 177 is directed specifically to the parent channel “/ALZN/Books” 174.

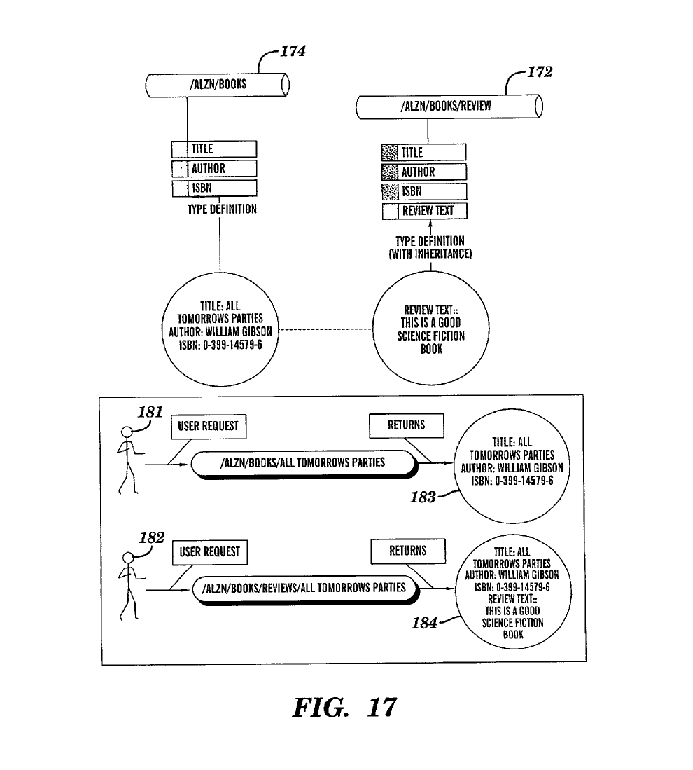

FIG. 17 illustrates object retrieval. In FIG. 17, a user 181 requests an object having attributes Title, Author, ISBN and as a result retrieves an object 183 attributes Title, Author, ISBN) from the parent channel “/ALZN/Books” 174. A user 182 requests an object having attributes Title, Author, ISBN, Review Text and as a result retrieves an object 184 (having attributes Title, Author, ISBN, Review Text) from the subchannel “/ALZN/Books/Review” 172.

FIG. 18, as well as FIG. 14 described supra, illustrates subscriptions. A subscription allows any channel to post messages to and receive messages from other channel, regardless of hierarchical position. A subscription gives a channel ability to extract a subset of the attributes defined for the publishing channel as as add default values to the missing attributes required the receiving channel's ontology. The attributes resulting from the subscription are called subscription attributes.

The subscription model of the present invention is a powerful tool as it allows messages and objects to be disseminated to appropriate sub-systems as well as ability to build on a message. In FIG. 14, the channel “/ALZN/Orders/”(“Orders”) is subscribed to the channel “/ALZN/Shopping-Cart/Checkout/”(“Checkout”) such any message posted to the channel Checkout is also posted to the channel Orders.

The channel Orders may rest on the Alzan server while the channel Checkout may exist closer to the point of use, which enables processes to be executed in a distributed fashion while still maintaining the functional validity of the system as a whole. To the application, there is no difference between publishing to a local channel that is closer to the point of use or a remote channel (such as across the Internet). The concept of subscriptions is also powerful in terms of its ability to disseminate only appropriate information to interested parties.

In FIG. 18, channel “/ALZN/Shipper/”(“Shipper”) and channel “/ALZN/Credit Cards/”(“Credit Cards”) are each subscribed to the channel “/ALZN/Orders/”(“Orders”) but are each not interested in all the information that is published to each. In particular, the channel Shipper doesn't need the Billing Info, and the channel Credit Cards doesn't need the Shipping Info. Thus each of the Shipper and Credit Card channels extracts only the fields that each requires.

Another feature of the subscriber philosophy is the dynamic interfacing with other systems. Any shipper system that wants to and is authorized to deliver shipments for Alzan just needs to subscribe its channel to channel Shipper. Similarly, any credit card system that wants to and is authorized to deliver for Alzan just needs to subscribe its channel to channel Credit Card. Since it is irrelevant that the shipper system' channel is local (e.g., closer to the point of use) remote (e.g., across the Internet), shipper channels such as “/FETEX/Order” and “/UPZ/Shipment” can be dynamically linked and integrated into the Alzan system. This interfacing allows channels, components and executable components to be shared amongst individual systems and thereby enabling the individual systems to act collectively as an integrated entity.

An ability to filter messages, based on subscription filters, from a sending system to a receiving system greatly enhances the interfacing options, since subscription filtering allows only relevant messages to enter the receiving system. For example, the channel “/UPZ/Shipment” may set a subscription filter that messages unless “Shipping Info. Shipper=UPZ” ppears in the message received by “/ALZN/Shipper.”

While particular embodiments of the present invention have been described herein for purposes of illustration, many modifications and changes will become apparent to those skilled in the art. Accordingly, the appended claims are intended to encompass all such modifications and changes as fall within the true spirit and scope of the present invention.

1. A system for distributed processing, comprising at least one Distributed Working Environment for Application Processing (DWEAP), wherein the at one DWEAP is coupleable to an Internet Service Provider (ISP), wherein the ISP is coupled to an Internet, wherein a main server is coupled to the Internet, wherein an application is coupled to the main server, and wherein each said DWEAP has an application cache for caching a runnable module (RUM) of the application.

2. The system of claim 1, wherein a database is coupled to the main server, wherein a database cache is coupled to at least one of said DWEAPs for caching a portion of the database, and wherein the portion of the database is required for execution of the application.

3. The system of claim 1, wherein the at least one DWEAP includes a first DWEAP and a second DWEAP, wherein the application cache of the first includes a first RUM of the application, wherein the application cache of the second DWEAP includes a second RUM of the application, and wherein execution of the application includes execution of the first RUM on the first DWEAP and execution of the second RUM on the second DWEAP.

4. The system of claim 3, further comprising a database coupled to the main server, wherein a first portion of the database is cached on the first DWEAP, wherein a second portion of the database is cached on the second DWEAP, wherein execution of the first RUM includes utilization of the first portion of the database, and wherein execution of the second RUM includes utilization the second portion of the database.

5. The system of claim 1, further comprising a client coupled to a first of the at least one DWEAP.

6. The system of claim 5, wherein the application is executable such that a portion of the application is runnable closer to the client.

7. The system of claim 6, wherein the portion of the application is the entire application.

8. The system of claim 5, wherein the application is executable such that a portion of the application is runnable near the client.

9. The system of claim 5, wherein the application is executable such that a portion of the application is runnable on the client.

10. The system of claim 5, wherein the application is executable such that a first portion of the application is runnable closer to the client and a second portion of the application is runnable on the main server.

11. The system of claim 5, wherein the application is executable such that a portion of the application is runnable closer to the client with a lower latency for execution of the application than if the entire application were run on the main server.

12. The system of claim 1, wherein the at least one DWEAP is coupled to the ISP.

13. A system for distributed processing, comprising at least one node, wherein the at least one node is coupleable to an Internet, wherein a main server is coupled to the Internet, wherein an application is coupled to the server, wherein each said node comprises a network server, a Distributed Working Environment for Application Processing (DWEAP) for execution of a runnable module (RUM) of the application, and an application module cache for caching the RUM.

14. The system of claim 13, wherein a database is coupled to the main wherein at least one of said nodes further comprises a synchronized cache for caching a portion of the database, and wherein the portion of database is required for execution of the application.

15. The system of claim 13, wherein the at least one node includes a first node and a second node, wherein the application cache of the first node includes a first RUM of the application, wherein the application cache of the second node includes a second RUM of the application, and wherein an execution of the application includes execution of the first RUM on the of the first node and execution of the second RUM on the DWEAP of the second node.

16. The system of claim 15, further comprising a database coupled to the main server, wherein a first portion of the database is cached on the first node, wherein a second portion of the database is cached on the second wherein execution of the first RUM includes utilization of the first portion of the database, and wherein execution of the second RUM includes utilization the second portion of the database.

17. The system of claim 15, wherein the first node is coupled to the second node.

18. The system of claim 13, further comprising a client coupled to a first of the at least one node.

19. The system of claim 18, further comprising a DWEAP coupled to the

20. The system of claim 18, further comprising an Internet Service Provider (ISP) coupled to the first node and to the client.

21. The system of claim 18, wherein the application is executable such that a portion of the application is runnable closer to the client.

22. The system of claim 18, wherein the portion of the application is the application.

23. The system of claim 18, wherein the application is executable such that a portion of the application is runnable near the client.

24. The system of claim 18, wherein the application is executable such that a portion of the application is runnable on the client.

25. The system of claim 18, wherein the application is executable such that a first portion of the application is runnable closer to the client and a second portion of the application is runnable on the main server.

26. The system of claim 18, wherein the application is executable such that a portion of the application is runnable closer to the client with a lower latency for execution of the application than if the entire application were run on the main server.

27. The system of claim 13, wherein the at least one node is coupled to the Internet.

28. An application comprising a plurality of runnable modules (RUMs), the application is coupled to a main server, wherein the main server is to an Internet, wherein at least one RUM of the plurality of RUMs is cached at one or more locations, and wherein the application is executable such that at least one RUM is runnable closer to a client.

29. The application of claim 28, wherein each of the one or more locations includes a Distributed Working Environment for Application Processing (DWEAP), and wherein the at least one RUM is runnable on at least one of the DWEAPs.

30. The application of claim 29, wherein each of the one or more locations include a node of a system for distributed processing, and wherein the node at each location includes the DWEAP at each location.

31. The application of claim 29, wherein the client is coupled to a DWEAP of the DWEAPS at the one or more locations, and wherein the application is executable such that the at least one RUM is runnable on the client.

32. The application of claim 28, wherein the application is executable such that the at least one RUM is runnable near the client.

33. The application of claim 28, wherein a non-cached RUM of the plurality RUMS is runnable only on the main server.

34. The application of claim 28, wherein a first RUM of the at least one RUM cached at a first DWEAP within the one or more locations, and wherein a second RUM of the at least one RUM is cached at a second DWEAP within the one or more locations.

35. The application of claim 34, wherein the first RUM is runnable on the client, and wherein the second RUM is runnable near the client.

36. The application of claim 34, wherein the first RUM is runnable near the client, and wherein the second RUM is runnable near the client.

37. The application of claim 34, wherein a non-cached RUM of the plurality RUMS is runnable only on the main server.

38. The application of claim 28, wherein execution of the application that includes running the at least one RUM closer to the client has a lower latency than if the entire application were run on the main server.

39. A database coupled to a main server, wherein the main server is coupled to an Internet, wherein the database comprises a plurality of database portions, wherein at least one database portion of the plurality of database portions is cached at one or more locations, and wherein the one or more locations are closer to a client.

40. The database of claim 39, wherein each of the one or more locations includes a Distributed Working Environment for Application Processing (DWEAP) for running a runnable module (RUM) which utilizes whatever of the database is cached at the DWEAP.

41. The database of claim 40, wherein each of the one or more locations include a node of a system for distributed processing, and wherein the node at each location includes the DWEAP at each location.

42. The database of claim 40, wherein the client is coupled to a DWEAP of DWEAPS at the one or more locations.

43. The database of claim 39, wherein the one or more locations are near the client.

44. The database of claim 39, wherein the database includes a non-cached portion that is not cached away from the main server.

45. The database of claim 39, wherein a first database portion of the at least one database portion is cached at a first location of the one or more and wherein a second database portion of the at least one database portion cached at a second location of the one or more locations.

46. The database of claim 45, wherein the first location is on the client, and wherein the second location is near the client.

47. The database of claim 45, wherein the first location is near the client, wherein the second location is near the client.

48. The database of claim 45, wherein the database includes a non-cached portion that is not cached away from the main server.

49. A system of communication, said system comprising a channel architecture having at least one channel path, wherein each said channel comprises N channels denoted as C₁, C₂, . . . , C_{N-1}, C_{N} in a hierarchical structure of /C₁/C₂/ . . . /C_{N-1}/C_{N}, wherein N is at least 2, wherein C₁ a root channel, wherein Cₙ is a subchannel having Cₙ₋₁ as a parent for n=2,3, . . . , N, wherein Cₙ has an ontology Oₘ for m=1,2, . . . , N, and wherein Oᵢ comprises all attributes included in Oᵢ₋₁ for i=2,3, . . . N.

50. The system of claim 49, wherein the at least one channel path comprises first channel path P₁ and a second channel path P₂, and wherein P₁ and P have a same root channel.

51. The system of claim 49, wherein the at least one channel path comprises first channel path P₁ and a second channel path P₂, and wherein P₁ and P have a different root channel.

52. The system of claim 49, wherein the at least one channel path comprises first channel path, wherein the first channel path has a subchannel C and a parent channel P of the subchannel C, and wherein the ontology of C at least one attribute not included in the ontology of P.

53. The system of claim 49, wherein the at least one channel path comprises first channel path, wherein the first channel path has a subchannel C, and wherein C comprises a component.

54. The system of claim 53, wherein the component includes a static object.

55. The system of claim 54, wherein the static object is selected from the group consisting of a message, a downloadable file, and a graphics file.

56. The system of claim 53, wherein the component includes a dynamic object.

57. The system of claim 53, wherein the component includes an executable module.

58. The system of claim 53, wherein C includes an executable interface for executing a runnable module (RUM).

59. The system of claim 58, wherein the executable interface stores the RUM.

60. The system of claim 58, wherein the executable interface does not store the RUM.

61. The system of claim 58, wherein C comprises meta data, wherein the data includes the name of the RUM, and wherein the meta data points to a method to call within the RUM.

62. The system of claim 53, wherein C comprises meta data.

63. The system of claim 62, wherein the meta data includes Multi-purpose Internet Mail Extensions (MIME) types.

64. The system of claim 63, wherein the MIME types include a type selected from the group consisting of a deliverable component, an edge component, deliverable executable component, and a channel component.

65. The system of claim 53, wherein the component includes a message.

66. The system of claim 53, wherein the component includes an attribute selected from the group consisting of expiration time, quality of service, source, name, globally unique identifier, owner, access control list, and combinations thereof.

67. The system of claim 49, wherein the at least one channel path comprises first channel path, wherein the first channel path has a subchannel C and a parent channel P of the subchannel C, wherein the ontology of P includes an attribute A, wherein the ontology of C includes the attribute A and an B, wherein a first message having the attributes A and B has been posted to wherein a subsequent message having the attribute A and not having the attribute B has been posted to P, and wherein the subsequent message was derived from the first message.

68. The system of claim 49, wherein a specified channel of the at least one channel path is destroyable.

69. The system of claim 49, wherein a subchannel of a current channel of the at least one channel path may be created.

70. The system of claim 49, wherein a current channel of the at least one channel path may be subscribed to a specified channel of the at least one channel path.

71. The system of claim 49, wherein a current channel of the at least one channel path may be unsubscribed from a specified channel of the at least channel path.

72. A system of communication over a distributed processing network, said system comprising:
the distributed processing network having a plurality of nodes, wherein each node is coupleable to an Internet, wherein a main server is coupled to the Internet, wherein an application is coupled to the main server, wherein each node comprises a network server, a Distributed Working Environment for Application Processing (DWEAP) for execution of a runnable module (RUM) of the application, and an application module cache for caching the RUM; and
a channel architecture having at least one channel path, wherein each said channel path comprises N channels denoted as C₁, C₂, . . . , C_{N-1}, C_{N} in hierachical structure of /C₁/C₂/ . . . /C_{N-1}/C_{N}, wherein N is at least 2, wherein C₁ is a root channel, wherein Cₙ is a subchannel having Cₙ₋₁ as a parent channel for n=2,3, . . . , N, wherein Cₙ has an ontology Oₘ for m=1,2, . . . , N, and wherein Oᵢ comprises all attributes included in Oᵢ₋₁ for i=2,3, . . . N, and wherein the distributed processing network uses the architecture to transfer the RUMs from the main server to the DWEAPs.

73. The system of claim 72, wherein a database is coupled to the main wherein at least one of said nodes further comprises a synchronized cache for caching a portion of the database, wherein the portion of the database is required for execution of the application, and wherein the distributed processing network uses the channel architecture to transfer the portion of the database from the main server to the synchronized database cache of the at least one of said nodes.

74. A subscription structure, comprising:
a first channel;
a second channel to which the first channel is subscribed; and
a component in the first channel, wherein the component is intended to be transported from the first channel to the second channel, wherein the component is intended to deliver at least one attribute to the second and wherein the first channel determines the at least one attribute.

75. The subscription structure of claim 74, further comprising a subscription filter through which the component must pass while en route from the first channel to the second channel, wherein the subscription filter tests the at least one attribute against a conditional match expression.

76. The subscription structure of claim 75, further comprising a channel through which the component must pass while en route from the first to the second channel, wherein the component must pass through the subscription filter before passing through the channel filter, and wherein the channel filter determines whether the component may be posted to the second channel.

77. The subscription structure of claim 74, further comprising a channel through which the component must pass while en route from the first to the second channel, and wherein the channel filter determines whether component may be posted to the second channel.

78. The subscription structure of claim 74, wherein the component is a message.

79. The subscription structure of claim 78, wherein the second channel comprises a logical filter which acts upon the message.

80. The subscription structure of claim 79, wherein the logical filter validates the message.

81. The subscription structure of claim 79, wherein the logical filter refers to logical object.

82. The subscription structure of claim 79, wherein the logical filter is an expression in terms of attributes of a third channel.

83. The subscription structure of claim 74, wherein the first channel is an interface channel, wherein the second channel includes an executable component, and wherein upon arrival of the component into the second channel the component causes the executable component to call a function.

84. The subscription structure of claim 74, wherein the first channel requires certificate-based authentication of the second channel prior to allowing the component to be transported from the first channel to the second channel.

85. The subscription structure of claim 74, wherein the second channel requires certificate-based authentication of the first channel prior to the component to be received by second channel from the first channel.

86. A two-way nodal communication network, comprising:
a first node;
a second node, wherein an object O may be sent from the first node to the second node or from the second node to the first node, wherein the first sends or receives O in a form F₁, and wherein the second node sends or receives O in a form F₂; and
a transport strategy, wherein if O is sent from the first node to the second node then the transport strategy converts O from F₁ into a common form after O is sent by the first node and the transport strategy subsequently converts O from the common form into F₂ prior to O being received by the second node, and wherein if O is sent from the second node to the first then the transport strategy converts O from F₂ into the common form after is sent by the second node and the transport strategy subsequently from the common form into F₁ prior to O being received by the first node.

87. The two-way nodal communication network of claim 86, wherein F₁ differs from F₂.

88. The two-way nodal communication network of claim 86, wherein F₁ =F₂.

89. The two-way nodal communication network of claim 86, wherein O is a message.

90. The two-way nodal communication network of claim 89, wherein F₁ is a first communication protocol, and wherein F₂ is a second communication protocol.

91. The two-way nodal communication network of claim 86, wherein O is a runnable module.

92. The two-way nodal communication network of claim 91, wherein F₁ is a function of a first software language, and wherein F₂ is a function of a software language.

93. The two-way nodal communication network of claim 86, wherein F₁ is a function of a first operating system platform, and wherein F₂ is a function a second operating system platform.

94. The two-way nodal communication network of claim 86, wherein F₁ is a function of a first hardware device platform, and wherein F₂ is a function second hardware device platform.

95. The two-way nodal communication network of claim 86, wherein F₁ is a function of a first software language, and wherein F₂ is a function of a software language.
